(19) United States
(12) Patent Application Publication
(10) Pub. No.: US 2023/0337003 A1
(43) Pub. Date: Oct. 19, 2023

(54) Speaker Identification Based Device Pairing

(71) Applicant: Plantronics, Inc., Santa Cruz, CA (US)

(72) Inventors: Peter L. Chu, Lexington, MA (US); Yibo Liu, Boxborough, MA (US); Kwan Kin Truong, John's Creek, GA (US); Hua Chen, Atlanta, GA (US); Daniel Jochelson, Frisco, TX (US)

(73) Assignee: Plantronics, Inc., Santa Cruz, CA (US)

(21) Appl. No.: 17/724,103

(22) Filed: Apr. 19, 2022

(51) Int. Cl. H04W 12/50; G06F 21/32; G10L 17/10; H04W 8/00

(52) U.S. Cl. CPC H04W 12/50; G06F 21/32; G10L 17/10; H04W 8/005

(57) ABSTRACT

Pairing two or more network devices in the same room or area is performed. Unique signature or speaker identification data of a user's voice is provided by the two or more network devices. The unique signature or speaker identification data provided by each of the two or more network devices is compared with one another and determined received at the same time. If unique signature or speaker identification data provided by each of the two or more network devices are the same and received at the same time, then pairing information is provided to the two more network devices to allow pairing.

### BACKGROUND

### Field

This disclosure relates generally to videoconferencing, and more specifically, pairing of network devices in the same room or area.

### Related Art

Network devices, such as internet protocol (IP) microphones, video conference units, video conference controllers, headsets, speakerphones, smartphones, etc. can be paired with one another, when their pairing information (i.e., IP addresses) are shared with each other. For example, a video conference controller can be paired with a video conference unit to connect to a video conferencing service, one or more IP microphones can be paired with a video conference unit to connect the IP microphones to an ethernet network, and a speakerphone can be paired with a video conference unit to enhance audio quality and user experience.

It is desirable that such pairing takes place when the network devices are in the same room or area. This provides for security, such that only pairing of network devices is performed when they are actually in use in the same room or area. Typical solutions include manual pairing using a pairing identifier (ID), using an ultrasonic signal to send the pairing ID from one network device to another, and broadcasting a pairing ID to network devices.

The known pairing solutions have disadvantages. Manually entering pairing ID is inconvenient to users and does not scale well to more than two devices, such as when network devices are initially set up or installed in a conference room or when users desire to pair their network devices when entering a conference room. The use of an ultrasound signal is unreliable due to its short wavelength, which can be blocked by objects and walls, and strong ultrasonic signals can cause bad interference to people and other equipment. In an audio/video conference, ultrasonic signals can interfere with microphone audio pickups. Broadcasting a pairing ID to network connected devices can result in pairing devices on a reachable network, but not in the same room or area. This compromises the security of knowing that the devices are in the same room or area.

### BRIEF DESCRIPTION OF THE DRAWINGS

Embodiments of the present invention may be better understood by referencing the accompanying drawings.

FIG. 1 is general illustration of a system for pairing of network devices in the same room or area using speaker identification (ID) as implemented in the present invention;

FIG. 2 is a generalized flowchart for pairing network devices in accordance with embodiments of the present invention;

FIG. 3 is a generalized flowchart for pairing two or more network devices in the same room or area using speaker identification (ID) in accordance with embodiments of the present invention; and

FIG. 4 is a general illustration of components of an information handling system as implemented in the present invention.

The use of the same reference symbols in different drawings indicates identical items unless otherwise noted. The figures are not necessarily drawn to scale.

### DETAILED DESCRIPTION

Embodiments of the present invention are intended to address the problem of pairing of network devices in the same room or area. Implementations provide for the use of speaker identification/recognition or speaker ID to pair two or more network devices.

Certain implementations provide pairing for an initial installation of network devices in a conference room or area. Network devices can include video bars, conference room controllers, wireless microphones, video cameras with microphones, etc. The network devices may or not be connected by the Internet. Implementations provide for an information technology (IT) administrator (installer) to speak and provide a voice that is recognized as unique to the administrator. A speaker ID preassigned to the voice and associates with a unique signature to the administrator. The network devices passes on the unique signature to a secure pairing management (PM) server (i.e., computer) that authenticates the unique signature and provides pairing information to the network devices.

For certain implementations, when users enter a conference room or area with a bring your own device (BYOD), such as laptop computer, headset, etc., temporary pairing occurs between the BYOD device with other network devices in the conference room or area. When a user comes into the room or area with the personal BYOD devices, the user speaks and provides a voice that is picked up by the other network devices. The other network devices may pass on the user voice to the PM server for conversion to a unique signature or perform the processing and pass on the unique signature to the PM server. The PM server can provide pairing information to the BYOD device(s) and other network devices to allow dynamic pairing. When the user leaves the room or area with their BYOD device(s), decoupling with the other network devices occurs.

A level of security is provided in the various implementations, since the PM server provides pairing information. Users do not access the pairing information. Furthermore, the inconvenience of manually entering pairing information is avoided by having network devices, including BYOD devices, automatically receive and download pairing information.

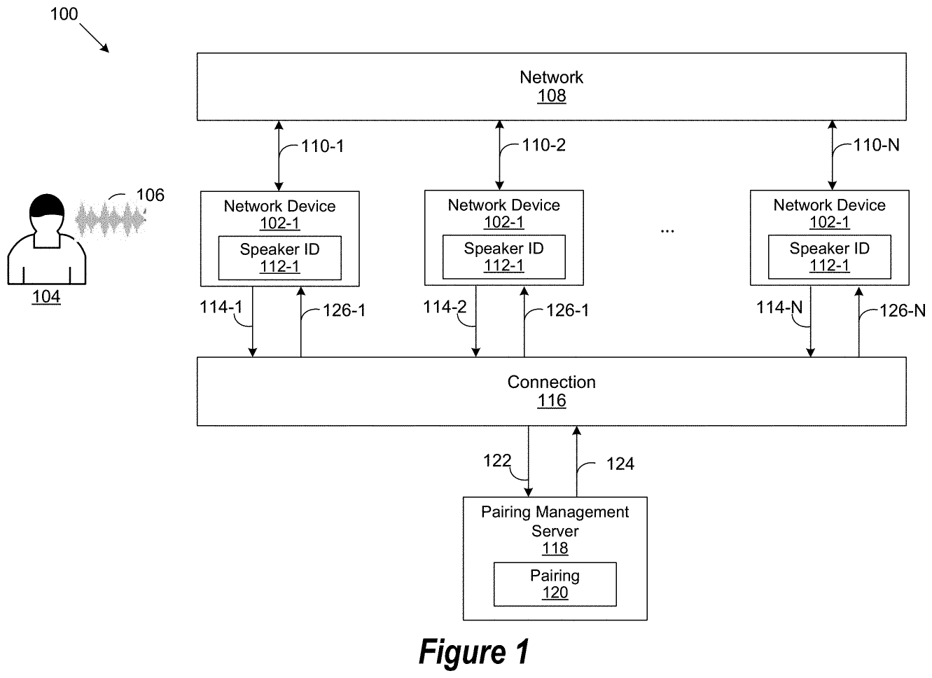

FIG. 1 is general illustration of a system for pairing of network devices in the same room or area using speaker ID. The system 100 includes two or more network devices 102, which are in the same room or area. The network devices 102 can include network information, such as an IP address, used for pairing with other network devices 102. Such network information is exchanged between network devices 102 to perform pairing.

Examples of network devices include internet protocol (IP) microphones, video conference units, video conference controllers, headsets, speakerphones, smartphones, etc. The network devices 102 can be categorized as primary/host/hub devices that are able to pair with other multiple network devices 102. For example, a video conference unit that pairs with multiple IP microphones. The network devices 102 can also be categorized as secondary/endpoint devices, and limited to pairing with one other network device 102. For example, a video conference endpoint and an IP microphone.

Implementations provide for the network devices 102 to be configured as an information handling system as further described herein, and described elements of information handling system, including a processor(s), I/O devices, such as a microphone, and memory. The network devices 102 communicate 110 to a network 108. Network 108 providing connection to the network devices 102.

A user 104 that desires to pair two or more of the network devices 102 enters and is present in the room or area of the network devices 102. The user 104 has access to two or more of the network devices 102, and desires to have the two or more network devices 102 paired with one another. In various implementations, the user 104 speaks and their voice 106 is picked up by microphones that are included in network devices 102.

The voice 106 of user 104 is recognized by a speaker ID application 112 that in various implementations is included in a network device 102. The speaker ID application 112 uses a microphone to receive voice 106 of the user 104. The voice 106 is associated with a speaker ID data or unique signature, that is recognized/identified by speaker ID application 112. The unique signature is specific to the user 104. In various implementations, the unique signature is associated with a number identifier. For example, the number identifier can be represented by a unique 192 digit number.

Unique signatures of various users 104 may be created and enrolled, provided to network devices, and stored/accessed by network devices 102 to allow speaker ID application 112 to verify a user 104 by their unique signature.

Implementations provide for the user 104 to request pairing of two or more of the network devices 102. The pairing is initiated by the user speaking (providing voice 106) to the network devices 102. In various implementations, the unique signature 114 that is identified at the two or more network devices 102 by their respective speaker ID application 112, is sent by a connection 116 to a pairing management server/computer or PM server 118. The PM server 118 is discoverable and reachable by all network devices 102. Implementations provide for the PM server 118 to be configured to identify the two or more network devices 102 to be paired, manages and passes pairing information and data to the two or more network devices 102 to be paired.

The PM server 118 can include pairing application 120 configured to receive speaker ID data or unique signatures 122 provided by network devices 104. When pairing of two or more network devices 102 is desired, pairing application 120 compares received unique signatures 122 to determine if they are the same and are received at the same time. This determination is indicative that the user and the two or more network devices 102 to be paired are in the same room or area. If the determination is such, then pairing information 124 is sent by the PM server 118 through connection 116. Pairing information 126 is received by the respective two or more network devices 102. PM server 118 can include information as to each of the network devices 102, including IP addresses of the network devices 102. Pairing information 124 and 126 includes data or information, such as IP addresses to allow the two or more network devices 102 to be paired.

In certain implementations, an authorized entity, such as an information technology (IT) administrator performs the pairing of network devices 102. Such pairings can be performed for installation of network devices 102 in a room or area. The entity (i.e., IT administrator) can have a pre-enrolled unique signature (speaker ID data) enrolled with the PM server 118, and is recognizable by network devices 102 (speaker ID application 112). Therefore, pairing of one or more network devices 102 occurs if the unique signature of the authorized entity is recognized.

In certain implementations, an additional password can be used, and entered manually or spoken by a user 104 to allow for installation of speaker ID 112 on network devices 102. Installation of speaker ID 112 can be performed on primary or secondary network devices 102 or both.

In certain implementations, to reduce computational resources on network devices 102, the voice 106 of user 104 is sent by the network devices to the PM server 118. The PM server 118 is configured with a speaker ID application 112 that determines the unique signature (speaker ID data).

In various implementations, a network device 102 can be personal to a user 104, such that the unique signature of the user 104 is included with the network device 102. An example of such a personal network device 102 can be a headset that is only used by a particular user 104. When pairing of such a personal network device 102 with other network devices 102, because the personal network device 102 has the unique signature of the user 104, the personal network device 102 does not have to receive voice 106 nor process voice 106 to determine the speaker ID data or unique signature. The unique signature of the user 104 is already included in the personal network device 102 and used for pairing as described herein with the network devices 102.

Various implementations further provide for the PM server 118 to be bypassed or not used when pairing of two or more network devices 102. In such implementations, the two or more network devices 102 are connected to one another by the network 108. For example, network 108 can be a Bluetooth network. For example, one of the network devices 102 can be a Bluetooth headset and the other network device 102 can be a Bluetooth enabled speakerphone. Each of the network devices 102 has speaker ID data or unique signature of the user 104. The unique signature is either installed/preexisting or determined as described herein using speaker ID application 112. The Bluetooth enabled speakerphone network device 102 includes pairing information. When Bluetooth enabled speakerphone network device 102 receives the voice 106 of user 104, speaker ID data or unique signatures is generated by speaker ID application 112, a determination can be made if the speaker ID data or unique signatures match. If such, then pairing information can be sent to the Bluetooth headset network device 102.

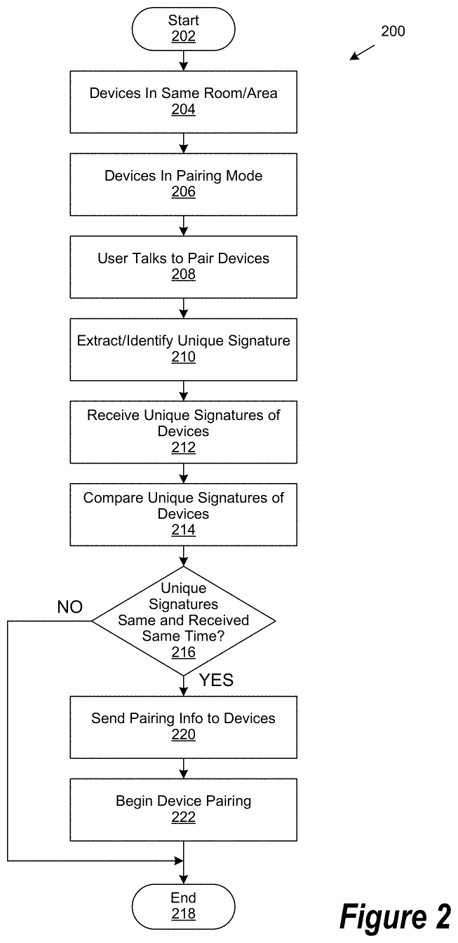

FIG. 2 is a generalized flowchart for pairing network devices that are in the same room or area. The order in which the method is described is not intended to be construed as a limitation, and any number of the described method steps may be combined in any order to implement the method, or alternate method.

At step 202, the process 200 starts. At step 204, networking devices 102 to be paired are located (installed) in the same room or area. At step 206, the networking devices 102 are placed in pairing mode, where for certain implementations, pairing mode is the default setting for an unpaired device. At step 208, user 104 enters the room or area, and starts to speak. The voice 106 of user 104 is received by the network devices. The voice 106 is used to extract/identify the unique signature of the voice 106 using speaker ID application 112.

At step 210, extraction/identification is performed as to the unique signature of the voice 106, which is sent to PM server 118. Other network device 102 data/information, such as media access control (MAC) address and serial number (S/N) may be also be sent. At step 212, the PM server 118 receives the unique signatures of the two or more networking devices 102 to be paired.

At step 214, comparison is performed of the unique signatures of the two or more networking devices 102 to be paired at the PM server 118. If the unique signatures match, the PM server 118 determines that the unique signatures are associated to the specific user 102. At step 216, a determination is made by the PM server 118 if the unique signatures are the same and received at the same time. The PM server 118 can be configured to filter out or ignore unique signatures (speaker ID data) that is not received at the same time, which leads to a determination that the networking devices 102 are not in the same room or are in the same room.

If the determination is made by the PM server 118 that the unique signatures are not the same and/or not received at the same time, following the “NO” branch of step 216, at step 218, the process 200 ends, and the individual network devices 102 remain in pairing mode, listening for potential users to speak. Otherwise, if determination is made by the PM server 118 that the unique signatures are the same and received at the same time, following the “YES” branch of step 216, at step 220, the PM server 118 sends pairing information 124 and 126 that can include data or information, such as IP addresses to allow network devices 102 to pair with one another. At step 222, the network devices 102 use received pairing information 124 and 126 to pair with one another. At step 218, process 200 ends.

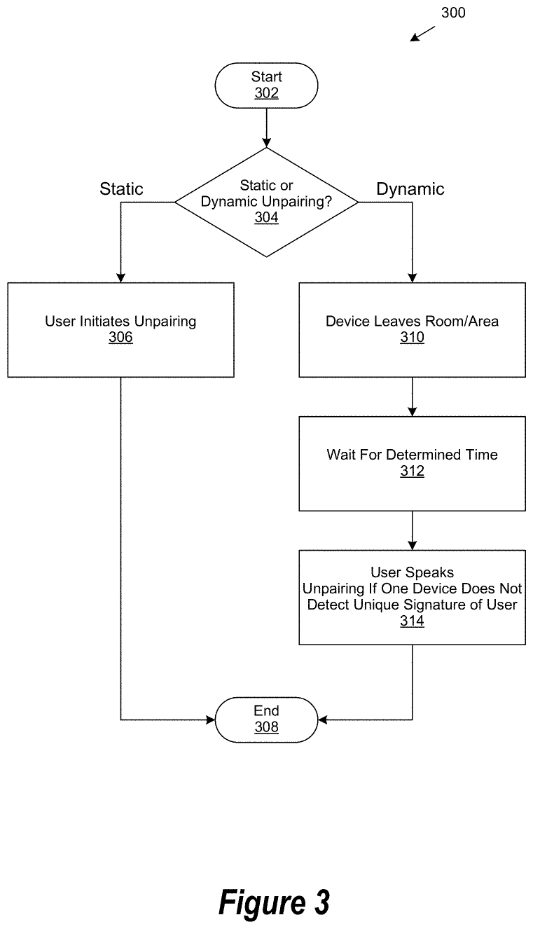

FIG. 3 is a generalized flowchart for unpairing network devices that are in the same room or area. The order in which the method is described is not intended to be construed as a limitation, and any number of the described method steps may be combined in any order to implement the method, or alternate method.

At step 302, the process 300 starts. At step 304, a determination is performed as to network device 102 pairing. In certain implementations, static pairing can be used for devices such as IP microphones, a conference endpoint, or a conference controller, and they normally stay with the primary device in the same room after paired. Dynamic pairing is suitable for bring your own device or BYOD situations, such as when a user brings their laptop computer to a conference room, where the laptop computer is enabled when the user walks into the conference room to join a meeting. The laptop computer is paired with other network devices 102. When the user walks out of the conference room, unpairing can take place dynamically. Furthermore, dynamic unpairing can take place when a BYOD network device 102 is no longer active.

If static unpairing, following the static branch of step 304, at step 306, a user 102 can initiate unpairing of the network devices 102. For example, a user interface button on one of the network devices 102 can be manually depressed/initiated to instruct unpairing of the network devices 102. At step 308, the process 300 ends.

If dynamic unpairing, following the dynamic branch of step 304, at step 310, one of the paired network devices 102 leaves the room or area with user 104. At step 312, a predetermined time period elapses. At step 314, if the other paired network devices 102 do not hear the voice 106 of user 104 and do not detect the unique signature of the user 104 after a the predetermined time period, then unpairing takes place. At step 308, the process 300 ends.

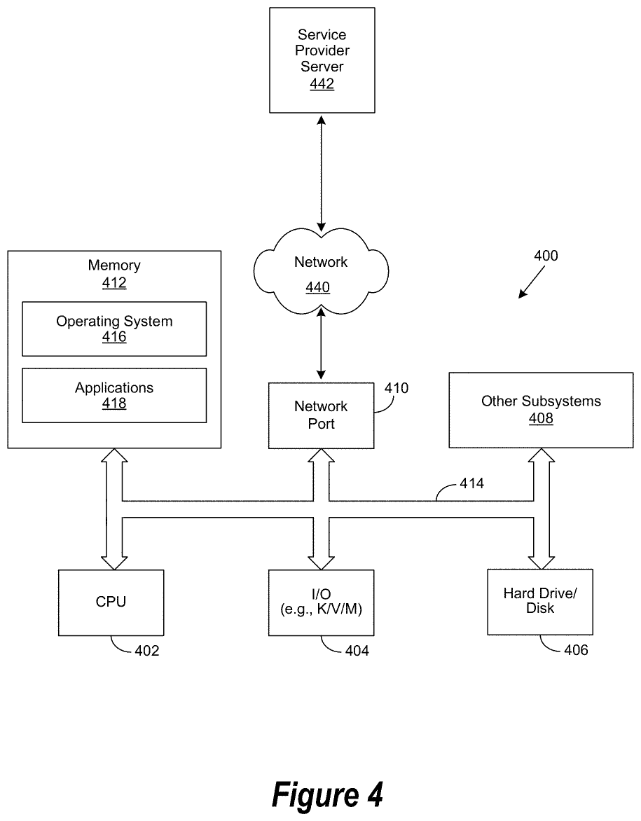

FIG. 4 is a generalized illustration of an information handling system 400 that can be used to implement the system and method of the present invention. Implementations provide for the information handling system 400 to include devices such as a notebook or laptop personal computer (PC), a smartphone, or other computing device, such as network devices 102 and pairing management server 118 as described herein.

The information handling system 400 includes a processor (e.g., central processor unit or “CPU”) 402, input/output (I/O) devices 404, such as a microphone, a speaker(s), a keyboard, a video/display, a mouse, and associated controllers (e.g., K/V/M), a hard drive or disk storage 406, and various other subsystems 408.

In various embodiments, the information handling system 400 also includes network port 410 operable to connect to a network 440, where network 440 can include one or more wired and wireless networks, including the Internet. Network 440 is likewise accessible by a service provider server 442. The information handling system 400 likewise includes system memory 412, which is interconnected to the foregoing via one or more buses 414. System memory 412 can be implemented as hardware, firmware, software, or a combination of such. System memory 412 further includes an operating system (OS) 416. Embodiments provide for the system memory 412 to include applications 418.

Although the invention is described herein with reference to specific embodiments, various modifications and changes can be made without departing from the scope of the present invention as set forth in the claims below. For example, the number of machine-learning models and associated granularities used and the nature of the application generating the well-defined normal behavior data. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

Unless stated otherwise, terms such as “first” and “second” are used to arbitrarily distinguish between the elements such terms describe. Thus, these terms are not necessarily intended to indicate temporal or other prioritization of such elements.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for pairing two or more network devices in the same room or area comprising:
receiving a unique signature of a user from each of the two or more network devices;
determining if received unique signatures from the two or more network devices are provided at the same time;
comparing if the received unique signatures from the two or more network devices are the same; and
providing pairing information to the two or more network devices if the received unique signatures arrive at the same time and are the same.

2. The computer-implementable method of claim 1, wherein the unique signature of the user is generated at the two or more network devices.

3. The computer-implementable method of claim 1, wherein the unique signature is stored in at least one of the two or more network devices.

4. The computer-implementable method of claim 1, wherein the method is performed by a pairing management server accessible by the two or more network devices.

5. The computer-implementable method of claim 1, wherein a signature is provided by authorized entity to perform pairing.

6. The computer-implementable method of claim 1, wherein a voice is received instead of the unique signature of a user from each of the two or more network devices, and the unique signature is generated from the received voice from the two or more network devices.

7. The computer-implementable method of claim 1 further comprising determining over a predetermined time if one or more network devices have left a room or area, and disabling pairing.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for pairing two or more network devices in the same room or area and comprising instructions executable by the processor and configured for:
receiving a unique signature of a user from each of the two or more network devices;
determining if received unique signatures from the two or more network devices are provided at the same time;
comparing if the received unique signatures from the two or more network devices are the same; and
providing pairing information to the two or more network devices if the received unique signatures arrive at the same time and are the same.

9. The system of claim 8, wherein the unique signature of the user is generated at the two or more network devices.

10. The system of claim 8, wherein the unique signature is stored in at least one of the two or more network devices.

11. The system of claim 8, wherein the system is a pairing management server accessible by the two or more network devices.

12. The system of claim 8, wherein a signature is provided by authorized entity to perform pairing.

13. The system of claim 8, wherein a voice is received instead of the unique signature of a user from each of the two or more network devices, and the unique signature is generated from the received voice from the two or more network devices.

14. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for pairing two or more network devices in the same room or area and comprising instructions executable by the processor and configured for:
receiving a voice from a user;
generating a unique signature from the received voice, wherein the unique signature is compared to other unique signatures from one or more network devices; and
receiving pairing information to the network, if the generated unique signature is the same as other unique signatures from the one or more network devices, wherein only network devices having the same unique signature receive pairing information to the network.

15. The system of claim 14, wherein the one or more network devices receive the voice from the user and generate a unique signature.

16. The system of claim 14, wherein at least one or more network devices receives and stores a unique signature.

17. The system of claim 14, wherein a signature is provided by authorized entity to perform pairing.

18. The system of claim 14, wherein pairing information is received from a pairing management server.

19. The system of claim 14, wherein instead of receiving pairing information, storing pairing information and providing the pairing information if the other unique signatures from the one or more network devices are the same as generated unique signature, wherein only network devices having the same unique signature receive pairing information to the network.

20. The system of claim 14 further comprising determining over a predetermined time if one or more network devices have left a room or area, and disabling pairing.
